(19) United States
(12) Patent Application Publication
(10) Pub. No.: US 2009/0047947 A1
(43) Pub. Date: Feb. 19, 2009

(54) DYNAMIC GATEWAY SELECTION BASED ON DATA SERVICE AND ROAMING PROTOCOL

(75) Inventors: Gerardo Giaretta, San Diego, CA (US); Kalle I. Ahmavaara, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/182,331

(22) Filed: Jul. 30, 2008

Related U.S. Application Data
(60) Provisional application No. 60/953,678, filed on Aug. 2, 2007.

(51) Int. Cl. H04W 36/00

(52) U.S. Cl. 455/432.1

(57) ABSTRACT

Techniques for supporting roaming in wireless communication networks are described. In one design, an access point name (APN) and a preferred roaming protocol for a user equipment (UE) roaming from a home network to a visited network may be obtained. The APN may be associated with a data service requested by the UE. The preferred roaming protocol may be GPRS Tunneling Protocol (GTP), Mobile Internet Protocol (MIP), Proxy Mobile Internet Protocol (PMIP), etc. A suitable network entity to provide data connectivity for the UE may be determined based on the APN and the preferred roaming protocol. In one design, the network entity may be (i) a packet data network (PDN) gateway in the home network if the preferred roaming protocol is GTP or (ii) a home agent in the home network if the preferred roaming protocol is PMIP or MIP.

The present application claims priority to provisional U.S. Application Ser. No. 60/953,678, entitled “METHOD AND APPARATUS FOR INTER GW PROTOCOL SELECTION AND ROAMING CONFIGURATION,” filed Aug. 2, 2007, assigned to the assignee hereof and incorporated herein by reference.

### BACKGROUND

I. Field

The present disclosure relates generally to communication, and more specifically to techniques for supporting roaming in wireless communication networks.

II. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A user equipment (UE) may be roaming from a home network with which the UE has a service subscription and may communicate with a visited network. The UE may support one or more data services. The visited network and the home network may each include a number of gateways. Each gateway may support one or more data services and one or more roaming protocols. It may be desirable to quickly and efficiently select a suitable gateway to provide data connectivity for the UE when roaming.

### SUMMARY

Techniques for supporting roaming in wireless communication networks are described herein. A UE may be able to receive one or more data services associated with one or more access point names (APNs). A home network may include one or more packet data network (PDN) gateways and/or one or more home agents. Each PDN gateway and each home agent may support one or more data services and one or more roaming protocols, e.g., GPRS Tunneling Protocol (GTP), Mobile Internet Protocol (MIP), Proxy Mobile Internet Protocol (PMIP), etc. A suitable PDN gateway or home agent may be selected for the UE based on an APN and a preferred roaming protocol for the UE.

In one design, an APN and a preferred roaming protocol for a UE roaming from a home network to a visited network may be obtained. The APN may be received from the UE or a home subscriber server (HSS) and may be associated with a data service requested by the UE. The preferred roaming protocol may be received from the HSS and may be GTP, MIP, PMIP, etc. A suitable network entity to provide data connectivity for the UE may be determined based on the APN and the preferred roaming protocol. In one design, a domain name system (DNS) query comprising the APN and the preferred roaming protocol may be sent to a DNS server. A DNS response comprising an address of the network entity may be received from the DNS server. In one design, the network entity may be a PDN gateway in the home network if the preferred roaming protocol is GTP and may be a home agent in the home network if the preferred roaming protocol is MIP or PMIP.

In one design, a mobility management entity (MME) in the visited network may obtain the APN and the preferred roaming protocol, e.g., GTP. The MME may discover a PDN gateway in the home network based on the APN and the preferred roaming protocol. In another design, a local PDN gateway or a serving gateway in the visited network may obtain the APN and the preferred roaming protocol, e.g., PMIP. The local PDN gateway or the serving gateway may discover a home agent in the home network based on the APN and the preferred roaming protocol. In yet another design, the UE may obtain the APN and the preferred roaming protocol, e.g., MIP. The UE may discover a home agent in the home network based on the APN and the preferred roaming protocol.

Various aspects and features of the disclosure are described in further detail below.

### BRIEF DESCRIPTION OF THE DRAWINGS

FIGS. 1A and 1B show example deployments of visited and home networks.

FIG. 2 shows a message flow for supporting roaming with GTP.

FIG. 3 shows a message flow for supporting roaming with PMIP.

FIG. 4 shows a message flow for supporting roaming with MIP.

FIG. 5 shows a process for supporting roaming in wireless networks.

FIG. 6 shows an apparatus for supporting roaming in wireless networks.

FIG. 7 shows a process for supporting roaming with GTP.

FIG. 8 shows an apparatus for supporting roaming with GTP.

FIG. 9 shows a process for supporting roaming with PMIP.

FIG. 10 shows an apparatus for supporting roaming with PMIP.

FIG. 11 shows a process for obtaining data connectivity while roaming.

FIG. 12 shows an apparatus for obtaining data connectivity while roaming.

FIG. 13 shows a process for obtaining data connectivity with MIP.

FIG. 14 shows an apparatus for obtaining data connectivity with MIP.

FIG. 15 shows a block diagram of a UE and various network entities.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). cdma2000 and UMB are described in documents from an organization named “3rd Generation Partnership Project 2” (3GPP2). For clarity, certain aspects of the techniques are described below for LTE, and LTE terminology is used in much of the description below.

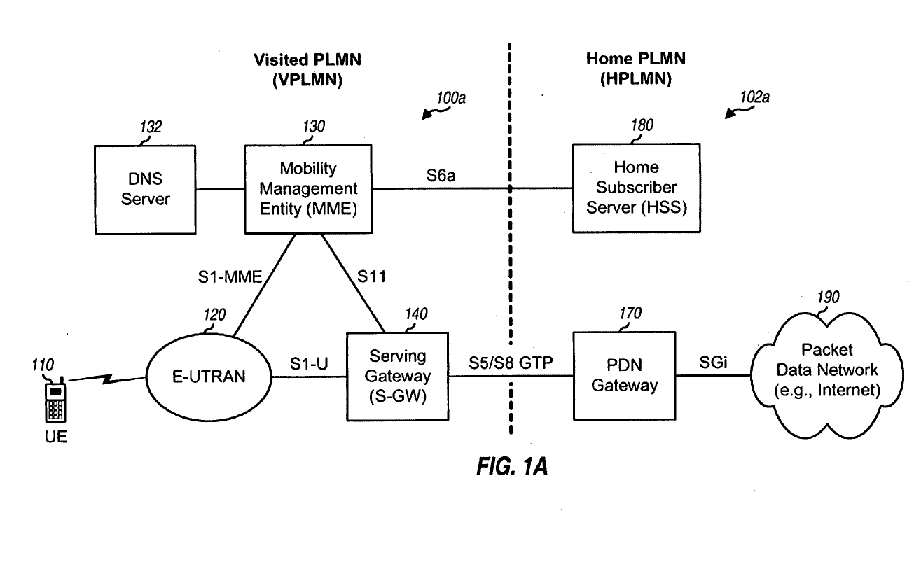

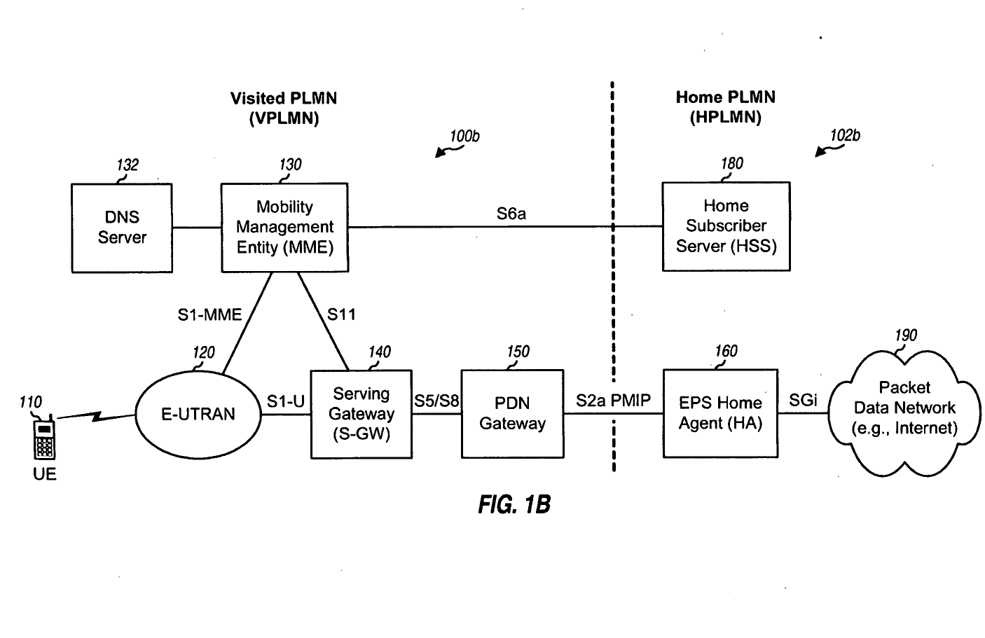

FIG. 1A shows an example deployment of a visited public land mobile network (VPLMN) 100a and a home PLMN (HPLMN) 102a. A PLMN may comprise one or more wireless communication networks, e.g., an LTE network, a UMTS network, a GSM network, etc. VPLMN 100a and HPLMN 102a may be deployed by different network operators, which may have a roaming agreement.

VPLMN 100a may include an Evolved Universal Terrestrial Radio Access Network (E-UTRAN) 120, an MME 130, and a serving gateway (S-GW) 140. E-UTRAN 120 may include evolved Node Bs (eNBs) that support radio communication for UEs. An eNB may be a fixed station that communicates with the UEs and may also be referred to as a Node B, a base station, an access point, etc. MME 130 may perform various functions such as control of signaling and security for a Non Access Stratum (NAS), authentication and mobility management of UEs, selection of gateways for UEs, bearer management functions, etc. Serving gateway 140 may terminate the interface towards E-UTRAN 120 and may perform various functions such as support for handover between eNBs, buffering, routing and forwarding of data for UEs, initiation of network-triggered service request procedure, accounting functions for charging, etc. E-UTRAN 120 may communicate with MME 130 via an S1-MME interface and with serving gateway 140 via an S1-U interface. MME 130 may communicate with serving gateway 140 via an S11 interface. A DNS server 132 may store a database of PDN gateways and home agents, their Internet Protocol (IP) addresses, and their supported APNs and roaming protocols. DNS server 132 may be part of VPLMN 100a or may be external to the VPLMN.

HPLMN 102a may include a PDN gateway 170 and an HSS 180. PDN gateway 170 may terminate an SGi interface towards a packet data network 190, which may be the Internet, a packet data network of a home network operator, or a public or private packet data network external to the home network operator. SGi is a reference point between a PDN gateway and a packet data network for provision of data services. PDN gateway 170 may perform functions such as packet filtering and IP address allocation for UEs, service level gating control and rate enforcement, dynamic host configuration protocol (DHCP) functions for client and server, gateway GPRS support node (GGSN) functionality, etc. HSS 180 may store subscription-related information (e.g., user profiles) and location information for UEs that have service subscriptions in HPLMN 102a. HSS 180 may perform authentication and authorization of UEs and may provide information for UEs to requesting network entities. HSS 180 may communicate with MME 130 via an S6a interface. PDN gateway 170 may communicate with serving gateway 140 via S5/S8 interfaces.

FIG. 1B shows an example deployment of a VPLMN 100b and an HPLMN 102b. VPLMN 100b may include E-UTRAN 120, MME 130, and serving gateway 140, which are described above for FIG. 1A. VPLMN 100b may further include a PDN gateway 150 that may perform the functions described above for PDN gateway 170 in FIG. 1A. HPLMN 102b may include an evolved packet system (EPS) home agent (HA) 160 and HSS 180. EPS HA 160 may maintain current location information for UEs that are roaming from HPLMN 102b and may route packets for these UEs. EPS HA 160 may be a gateway dedicated as a home agent or may be a gateway that can provide of home agent functionality as well as other functionalities.

VPLMNs 100a and 100b and HPLMNs 102a and 102b may include other network entities not shown in FIGS. 1A and 1B for simplicity. The network entities in FIGS. 1A and 1B may also be referred to by other names in other systems. For example, a home agent may be referred to as a local mobility anchor (LMA) or some other name. The various network entities in VPLMNs 100a and 100b and HPLMNs 102a and 102b are described in 3GPP TS 36.300, entitled “Evolved Universal Terrestrial Radio Access (E-UTRA) and Evolved Universal Terrestrial Radio Access Network (E-UTRAN); Overall description,” and in 3GPP TS 23.401, entitled “General Packet Radio Service (GPRS) enhancements for Evolved Universal Terrestrial Radio Access Network (E-UTRAN) access.” These documents are publicly available from 3GPP. In the description below, VPLMN 100 can refer to VPLMN 100a and/or 100b, and HPLMN 102 can refer to HPLMN 102a and/or 102b.

In FIGS. 1A and 1B, a UE 110 may have a service subscription with HPLMN 102 and may have its subscription-related information stored in HSS 180. UE 110 may be roaming and may communicate with E-UTRAN 120 in VPLMN 100. UE 110 may be able to receive one or more data services such as Internet connectivity, short message service (SMS), instant messaging (IM), wireless application protocol (WAP) access, multimedia streaming, multimedia messaging, etc. The data services may also be referred to as IP multimedia subsystem (IMS) services. Each data service may be associated with an APN, which may be associated with a PDN to which the UE can be connected, a set of settings to use for a data connection, settings in the UE for the data connection, etc. A data connection may be an association between a UE represented by an IP address and a PDN represented by an APN. A data connection may also be referred to as an IP connection, a PDN connection, etc.

An APN may be given by a string for a logical name used to select a PDN gateway or a home agent for a data service. Different network operators may define APN differently. For example, a network operator may define an APN to include (i) an operator identifier (ID) that identifies the network operator and (ii) a network ID that specifies routing information for the network operator. A network operator may also define an APN based on service, e.g., “sms.xyz.com”, where “sms” denotes a service and “xyz” is the name of the network operator. In general, an APN may specify a point of attachment for a UE for a particular data service.

Data connectivity for roaming UEs may be supported with various roaming protocols such as GTP, MIP and PMIP. GTP is an IP-based roaming protocol used in 3GPP networks and includes GTP-C and GTP-U. GTP-C is used for signaling between network entities (e.g., between serving gateways and PDN gateways) to activate, deactivate, and update sessions for UEs. GTP-U is used for carrying traffic data for the UEs between E-UTRAN 120 and the network entities.

PMIP is a network-based roaming protocol that enables IP mobility for a UE without requiring the UE to participate in mobility-related signaling. With PMIP, the network is responsible for managing IP mobility on behalf of the UE, for tracking the movement of the UE, and for initiating required mobility signaling on behalf of the UE.

MIP is a UE-based roaming protocol that allows a UE to roam from network to network while maintaining a permanent IP address. The UE may be identified by its home address regardless of its current location. While roaming, the UE may register with a home agent in the home network and may be associated with a care-of address that gives information about the current UE location. Data for the UE may then be routed through the home agent. The UE may change its point-of-attachment to the Internet without changing its IP address, which may then allow the UE to maintain transport and higher-layer connections while mobile.

Table 1 lists various inter-gateway/roaming protocol configurations that may be supported for data services for UE 110.

TABLE 1

| Configuration | Description |
|---|---|
| Configuration 1 for GTP | SGi from PDN gateway 170 in HPLMN, with GTP between |
| | serving gateway 140 and PDN gateway 170, as shown in FIG. 1A |
| Configuration 2 for PMIP | SGi from EPS HA 160 in HPLMN, with PMIP between PDN |
| | gateway 150 and EPS HA 160, as shown in FIG. 1B. |
| Configuration 3 for MIP | SGi from EPS HA 160 in HPLMN, with MIP between UE 110 and |
| | EPS HA 160, and PDN gateway 150 acting as a local gateway in |
| | VPLMN, as shown in FIG. 1B. |

UE 110 may be able to receive one or more data services associated with one or more APNs. Each PDN gateway and each EPS HA may support one or more data services and one or more roaming protocols, e.g., GTP, PMIP, and/or MIP. It may be desirable to dynamically determine a suitable PDN gateway or EPS HA for UE 110, to select a proper inter-gateway/roaming protocol configuration, and to select a proper SGi termination when UE 110 attaches to the visited network based on the capabilities of the UE, the capabilities of the home network, and the policies of the home network operator.

In an aspect, a suitable PDN gateway or EPS HA may be selected for roaming UE 110 based on an APN and a preferred roaming protocol for the UE. The APN may be indicative of the desired data service and may be provided by the UE or the HPLMN. The preferred roaming protocol may be designated for use for the UE and may also be provided by the UE or the HPLMN.

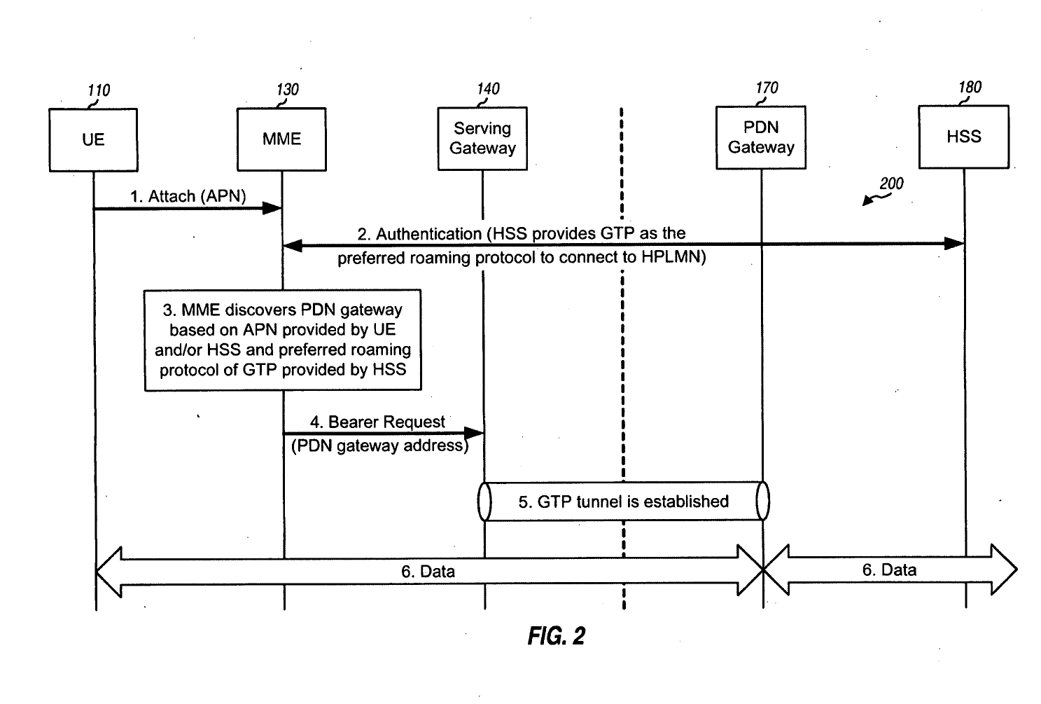

FIG. 2 shows a design of a message flow 200 for supporting roaming with GTP. For clarity, the communication between UE 110 and E-UTRAN 120 is omitted in FIG. 2. Message flow 200 may be implemented by the network entities shown in FIG. 1A.

UE 110 may initiate an attach procedure by sending an Attach Request message to E-UTRAN 120, which may forward the message to MME 130 (step 1). This message may include UE identity information (e.g., an International Mobile Subscriber Identity (IMSI) or a Globally Unique Temporary Identity (GUTI)), UE capabilities, PDN type, security information, etc. The message may also include an APN for a data service desired by UE 110 (as shown in FIG. 2) or may omit the APN. UE 110, MME 130 and HSS 180 may then perform an authentication procedure to authenticate UE 110 (step 2). HSS 180 may store subscription-related information for UE 110 and may provide information such as the data services authorized for UE 110 and the associated APNs. MME 130 may receive an APN from UE 110 (as shown in FIG. 2) and/or from HSS 180 (not shown in FIG. 2). MME 130 may also receive from HSS 180 an indication that GTP is the preferred roaming protocol to connect UE 110 to the HPLMN (step 2). GTP may be selected based on the UE capabilities, the home network capabilities, the policies of the home network operator, and/or other considerations.

MME 130 may discover a suitable PDN gateway for UE 110 based on the APN provided by UE 110 and/or HSS 180 and the preferred roaming protocol of GTP provided by HSS 180 (step 3). For step 3, MME 130 may send a DNS query containing the APN and GTP. The DNS query may be an A query, an AAAA query, or a SRV query. In one design, the APN and the preferred roaming protocol may be provided separately, e.g., by specifying GTP explicitly in an SRV query. In another design, the APN and the preferred roaming protocol may be provided together, e.g., by specifying GTP as decoration of a fully qualified domain name (FQDN). For example, an FQDN may be given by a string of “gtp.ipv6.xyz.com”, where “gtp” indicates the preferred roaming protocol of GTP, “ipv6” indicates use of IPv6 for a data connection for UE 110, and “xyz” indicates the domain name of a PDN gateway to use for the data connection. The FQDN may be sent in an A query to obtain an IP version 4 (IPv4) address or an AAAA query to obtain an IP version 6 (IPv6) address. In yet another design, GTP may be a default option, and an FQDN based on a plain APN may be used to discover the PDN gateway that supports GTP. In any case, DNS server 132 may receive the DNS query from MME 130 and may determine that PDN gateway 170 is associated with the APN and GTP provided in the DNS query. DNS server 132 may then return a DNS response containing an IP address of PDN gateway 170.

MME 130 may also select serving gateway 140 based on network topology (e.g., to reduce the likelihood changing serving gateway), load balancing between serving gateways, etc. MME 130 may then send a Bearer Request message to serving gateway 140 (step 4). This message may include pertinent information such as the UE identity, the PDN gateway address, the APN, etc. Serving gateway 140 may communicate with PDN gateway 170 using the PDN gateway address received from MME 130 and may establish a GTP tunnel with PDN gateway 170 for UE 110 (step 5). UE 110 may thereafter exchange data with external entities via PDN gateway 170 using the GTP tunnel (step 6).

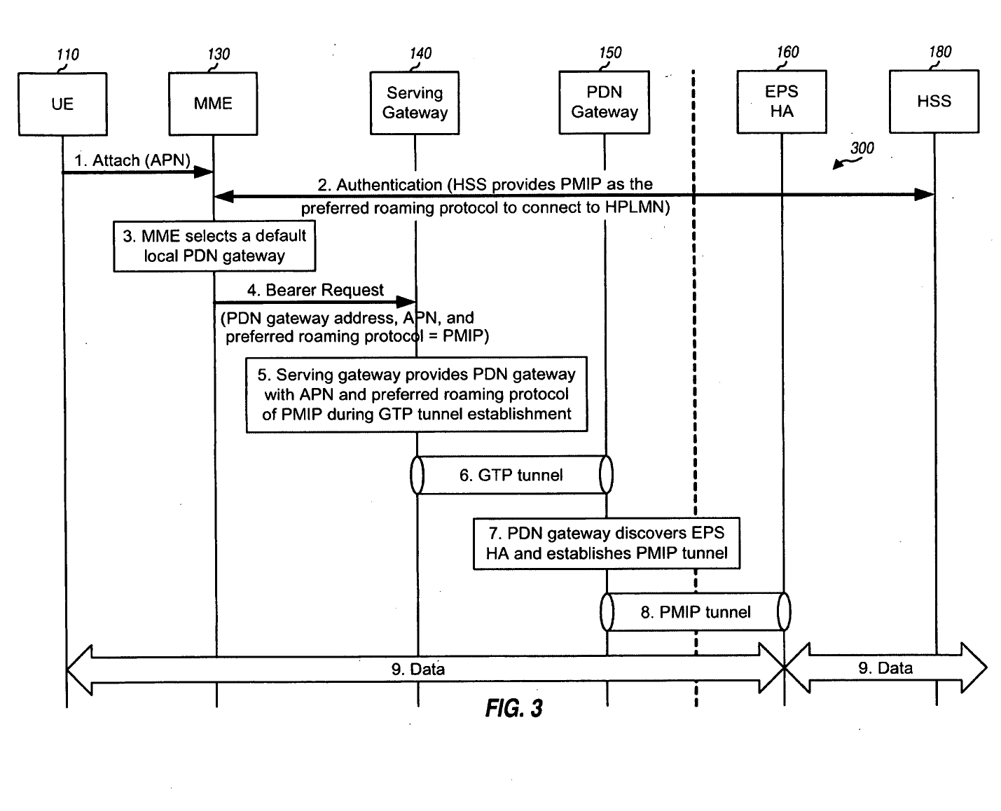

FIG. 3 shows a design of a message flow 300 for supporting roaming with PMIP. For clarity, the communication between UE 110 and E-UTRAN 120 is omitted in FIG. 3. Message flow 300 may be implemented by the network entities shown in FIG. 1B.

UE 110 may initiate an attach procedure by sending an Attach Request message to E-UTRAN 120, which may forward the message to MME 130 (step 1). The message may or may not include an APN for a data service desired by UE 110. UE 110, MME 130 and HSS 180 may then perform an authentication procedure to authenticate UE 110 (step 2). MME 130 may receive an APN from UE 110 (as shown in FIG. 2) and/or from HSS 180 (not shown in FIG. 2). MME 130 may also receive from HSS 180 an indication that PMIP is the preferred roaming protocol to connect UE 110 to the HPLMN (step 2). MME 130 may select PDN gateway 150, which may be a default local PDN gateway, and may also select serving gateway 140.

MME 130 may then send a Bearer Request message to serving gateway 140 (step 4). This message may include information such as the UE identity, the PDN gateway address, the APN, the preferred roaming protocol of PMIP, etc. Serving gateway 140 may communicate with PDN gateway 150 using the PDN gateway address received from MME 130 and may establish a GTP tunnel with PDN gateway 170 (step 6). Serving gateway 140 may provide the APN and the preferred roaming protocol of PMIP to PDN gateway 150 during the GTP tunnel establishment (step 5).

PDN gateway 150 may discover a suitable EPS HA for UE 110 based on the APN and the preferred roaming protocol of PMIP received from serving gateway 140 (step 7). For step 7, PDN gateway 150 may send a DNS query containing the APN and PMIP. DNS server 132 may return a DNS response containing an IP address of EPS HA 160, which may be associated with the APN and PMIP included in the DNS query. PDN gateway 150 may then communicate with EPS HA 160 to establish a PMIP tunnel for UE 110 (step 8). UE 110 may thereafter exchange data with external entities via EPS HA 160 using the PMIP tunnel (step 9).

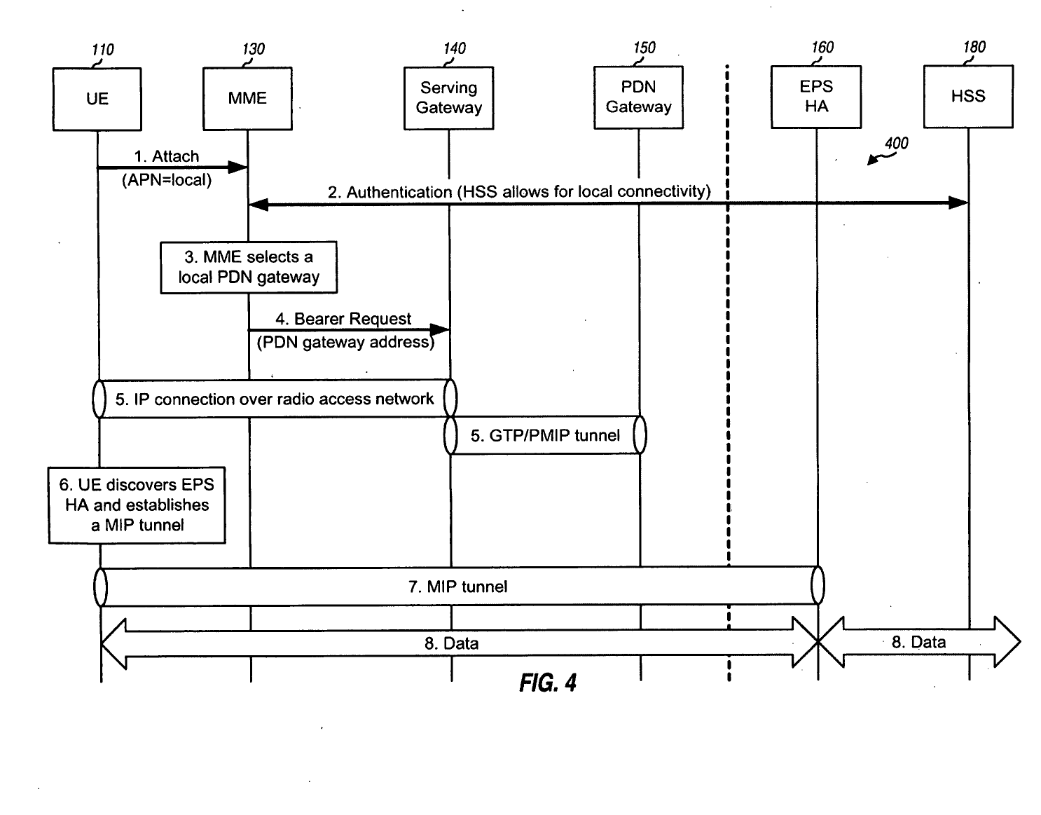

FIG. 4 shows a design of a message flow 400 for supporting roaming with MIP. For clarity, the communication between UE 110 and E-UTRAN 120 is omitted in FIG. 4. Message flow 400 may be implemented by the network entities shown in FIG. 1B.

UE 110 may initiate an attach procedure by sending an Attach Request message to E-UTRAN 120, which may forward the message to MME 130 (step 1). The message may include an APN for a local connection. UE 110, MME 130 and HSS 180 may then perform an authentication procedure to authenticate UE 110 (step 2). MME 130 may receive from HSS 180 an indication that local connectively is allowed for UE 110 (step 2). The indication of local connectivity from UE 110 and/or HSS 180 may implicitly indicate that MIP will be used for UE 110. MME 130 may select PDN gateway 150, which may be a default local PDN gateway, and may also select serving gateway 140 (step 3).

MME 130 may then send a Bearer Request message to serving gateway 140 (step 4). This message may include information such as the UE identity, the local PDN gateway address, etc. UE 110 may then communicate with serving gateway 140 via E-UTRAN 120 to establish a connection (step 5). Serving gateway 140 may establish a GTP or PMIP tunnel with local PDN gateway 150 based on local configuration (also step 5).

UE 110 may discover a suitable EPS HA based on the APN and the preferred roaming protocol of MIP known by the UE (step 6). For step 6, UE 110 may send a DNS query containing the APN and MIP. DNS server 132 may return a DNS response containing an IP address of EPS HA 160, which may be associated with the APN and MIP included in the DNS query. UE 110 may then communicate with EPS HA 160 to establish a MIP tunnel for the UE (step 7). UE 110 may thereafter exchange data with external entities via EPS HA 160 using the MIP tunnel (step 8).

For simplicity, FIGS. 2 through 4 show only signaling to establish a data connection for UE 110. UE 110 and E-UTRAN 120 may also exchange signaling to establish a radio link between the UE and the E-UTRAN. Other signaling may also be exchanged between the various network entities for other functions.

The dynamic gateway selection techniques described herein may be used during network attachment, as shown in FIGS. 2 through 4. The techniques may also be used for service requests and/or other scenarios.

In the designs shown in FIGS. 2 and 3, HSS 180 may provide MME 130 with the supported roaming protocols (e.g., GTP and/or PMIP) and the preferred roaming protocol (e.g., GTP or PMIP). MME 130 or some other network entity may use this information to select a suitable PDN gateway or home agent for UE 110.

If GTP is the preferred roaming protocol, as shown in FIG. 2, then MME 130 may select a PDN gateway in the HPLMN that can support GTP and provide the data service identified by an APN. MME 130 may discover this PDN gateway based on the APN provided by UE 110 and/or HSS 180, e.g., by performing a DNS query based on the APN.

If PMIP is the preferred roaming protocol, as shown in FIG. 3, then MME 130 may select a default local PDN gateway in the VPLMN. MME 130 may provide information (e.g., the APN) to discover a suitable EPS HA for UE 110. The local PDN gateway or a serving gateway may perform a DNS query based on the APN in order to discover an EPS HA that can support PMIP and provide the data service identified by the APN.

If MIP is the preferred roaming protocol, as shown in FIG. 4, then UE 110 may ask for and/or HSS 180 may instruct MME 130 to provide local connectivity for UE 110. UE 110 may then discover a suitable EPS HA that can support MIP and provide the data service identified by the APN, e.g., by performing a DNS query based on the APN.

For the designs shown in FIGS. 2 through 4, MME 130 may perform dynamic gateway selection. In another design, serving gateway 140 or PDN gateway 150 may perform dynamic gateway selection. In yet another design, a designated network entity may perform dynamic gateway selection. For these designs, MME 130 may provide the APN and the preferred roaming protocol to the designated network entity, which may then select a suitable PDN gateway or home agent based on the information.

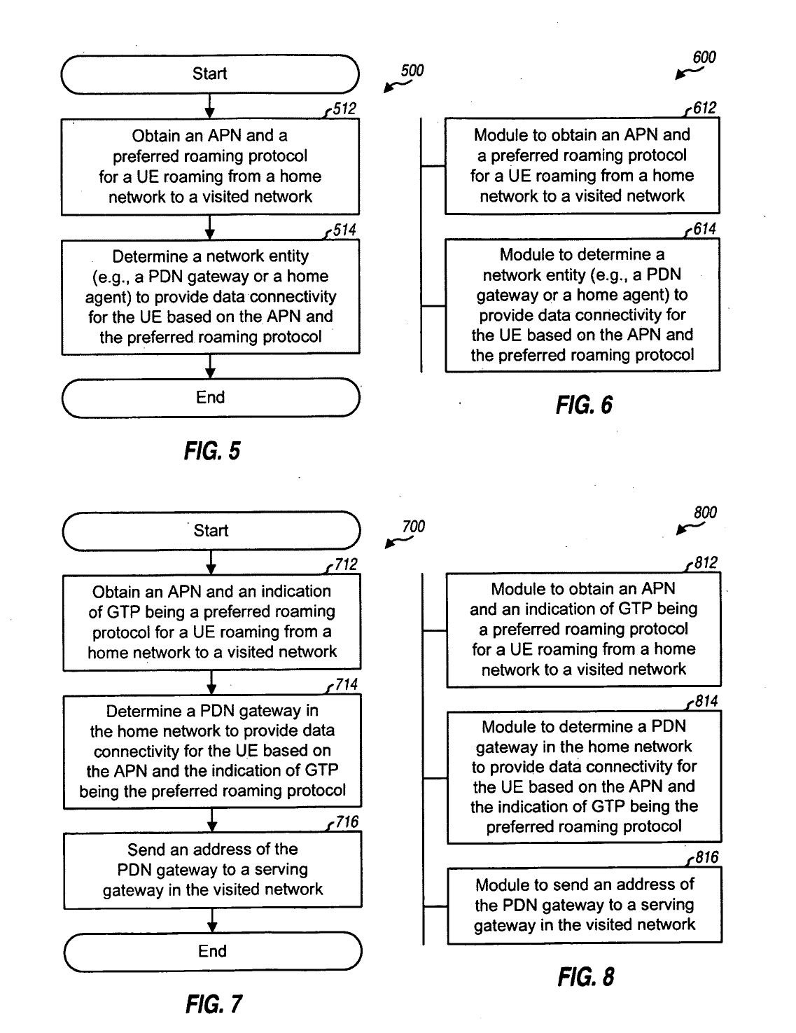

FIG. 5 shows a design of a process 500 for supporting roaming in wireless communication networks. Process 500 may be performed by an MME, a serving gateway, a PDN gateway, a UE, or some other entity.

An APN and a preferred roaming protocol for a UE roaming from a home network to a visited network may be obtained (block 512). In one design of block 512, the APN may be received from the UE or an HSS in the home network and may be associated with a data service requested by the UE. The preferred roaming protocol may be received from the HSS and may be GTP, MIP, PMIP, or some other roaming protocol.

A network entity to provide data connectivity for the UE may be determined based on the APN and the preferred roaming protocol (block 514). In one design of block 514, a DNS query comprising the APN and the preferred roaming protocol may be sent, and a DNS response comprising an address of the network entity may be received. In one design, the network entity may be a PDN gateway in the home network if the preferred roaming protocol is GTP and may be a home agent in the home network if the preferred roaming protocol is PMIP or MIP. A PDN gateway in either the visited network or the home network may be selected based on the preferred roaming protocol, with data connectivity for the UE being provided through the PDN gateway. This PDN gateway (i) may be the network entity providing data connectivity for the UE if GTP is the preferred roaming protocol or (ii) may communicate with the network entity providing data connectivity for the UE if PMIP or MIP is the preferred roaming protocol.

In one design, an MME in the visited network may obtain the APN and the preferred roaming protocol. The MME may discover a PDN gateway in the home network (as the network entity providing data connectivity for the UE) based on the APN and the preferred roaming protocol, e.g., as shown in FIG. 2. In another design, a PDN gateway or a serving gateway in the visited network may obtain the APN and the preferred roaming protocol. The PDN gateway or the serving gateway may discover a home agent in the home network (as the network entity providing data connectivity for the UE) based on the APN and the preferred roaming protocol, e.g., as shown in FIG. 3. In yet another design, the UE may obtain the APN and the preferred roaming protocol. The UE may discover a home agent in the home network as the network entity based on the APN and the preferred roaming protocol, e.g., as shown in FIG. 4.

FIG. 6 shows a design of an apparatus 600 for supporting roaming in wireless communication networks. Apparatus 600 includes a module 612 to obtain an APN and a preferred roaming protocol for a UE roaming from a home network to a visited network, and a module 614 to determine a network entity (e.g., a PDN gateway or a home agent) to provide data connectivity for the UE based on the APN and the preferred roaming protocol.

FIG. 7 shows a design of a process 700 for supporting roaming in wireless communication networks. Process 700 may be performed by an MME or some other entity. An APN and an indication of GTP being a preferred roaming protocol for a UE roaming from a home network to a visited network may be obtained (block 712). In one design of block 712, the APN may be received from the UE or an HSS in the home network, and the indication of GTP being the preferred roaming protocol may be received from the HSS. A PDN gateway in the home network to provide data connectivity for the UE may be determined based on the APN and the indication of GTP being the preferred roaming protocol (block 714). In one design of block 714, a DNS query comprising the APN and the indication of GTP being the preferred roaming protocol may be sent, and a DNS response comprising an address of the PDN gateway may be received. The address of the PDN gateway may be sent to a serving gateway in the visited network (block 716). The serving gateway may establish a GTP tunnel with the PDN gateway for transporting data for the UE.

FIG. 8 shows a design of an apparatus 800 for supporting roaming in wireless communication networks. Apparatus 800 includes a module 812 to obtain an APN and an indication of GTP being a preferred roaming protocol for a UE roaming from a home network to a visited network, a module 814 to determine a PDN gateway in the home network to provide data connectivity for the UE based on the APN and the indication of GTP being the preferred roaming protocol, and a module 816 to send an address of the PDN gateway to a serving gateway in the visited network.

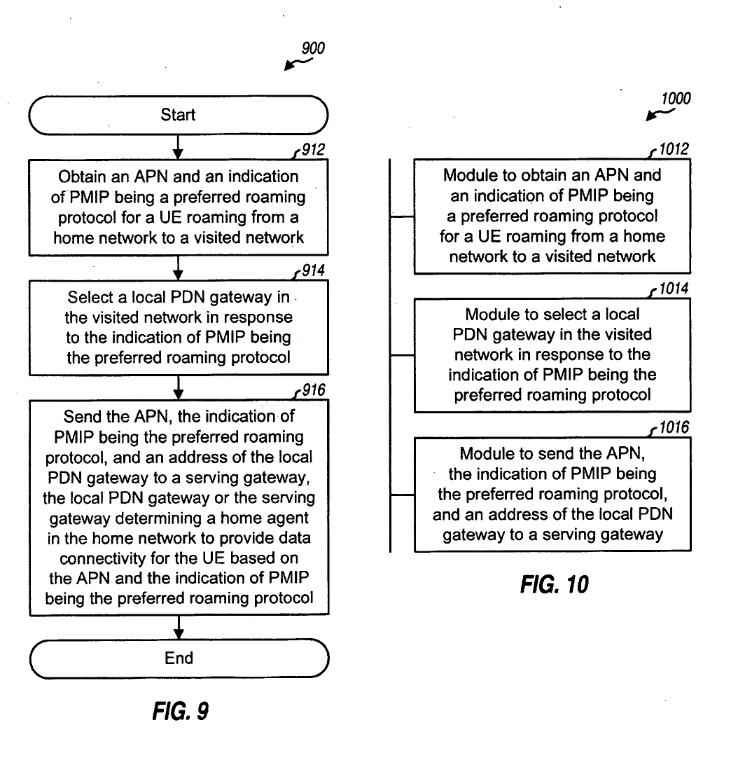

FIG. 9 shows a design of a process 900 for supporting roaming in wireless communication networks. Process 900 may be performed by an MME or some other entity. An APN and an indication of PMIP being a preferred roaming protocol for a UE roaming from a home network to a visited network may be obtained (block 912). In one design of block 912, the APN may be received from the UE or an HSS in the home network, and the indication of PMIP being the preferred roaming protocol may be received from the HSS. A local PDN gateway in the visited network may be selected in response to the indication of PMIP being the preferred roaming protocol (block 914). The APN, the indication of PMIP being the preferred roaming protocol, and an address of the local PDN gateway may be sent to a serving gateway (block 916). The local PDN gateway or the serving gateway may determine a home agent in the home network to provide data connectivity for the UE based on the APN and the indication of PMIP being the preferred roaming protocol.

FIG. 10 shows a design of an apparatus 1000 for supporting roaming in wireless communication networks. Apparatus 1000 includes a module 1012 to obtain an APN and an indication of PMIP being a preferred roaming protocol for a UE roaming from a home network to a visited network, a module 1014 to select a local PDN gateway in the visited network in response to the indication of PMIP being the preferred roaming protocol, and a module 1016 to send the APN, the indication of PMIP being the preferred roaming protocol, and an address of the local PDN gateway to a serving gateway.

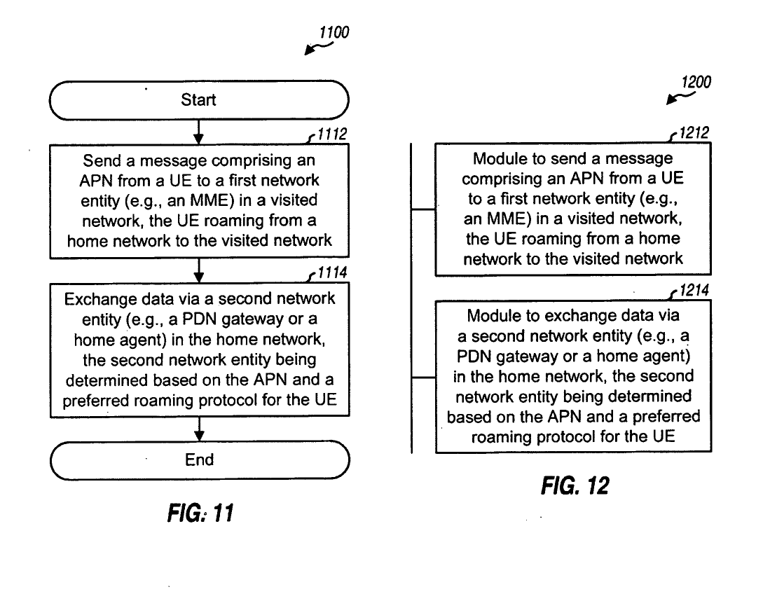

FIG. 11 shows a design of a process 1100 for obtaining data connectivity while roaming between wireless communication networks. Process 1100 may be performed by a UE or some other entity. A message comprising an APN may be sent from a UE to a first network entity (e.g., an MME) in a visited network, with the UE roaming from a home network to the visited network (block 1112). Data may be exchanged via a second network entity in the home network, with the second network entity being determined based on the APN and a preferred roaming protocol for the UE (block 1114). In one design, the second network entity may be a PDN gateway determined based on the APN and GTP being the preferred roaming protocol. In another design, the second network entity may be a home agent determined based on the APN and PMIP or MIP being the preferred roaming protocol.

FIG. 12 shows a design of an apparatus 1200 for obtaining data connectivity while roaming between wireless communication networks. Apparatus 1200 includes a module 1212 to send a message comprising an APN from a UE to a first network entity (e.g., an MME) in a visited network, with the UE roaming from a home network to the visited network, and a module 1214 to exchange data via a second network entity (e.g., a PDN gateway or a home agent) in the home network, with the second network entity being determined based on the APN and a preferred roaming protocol for the UE.

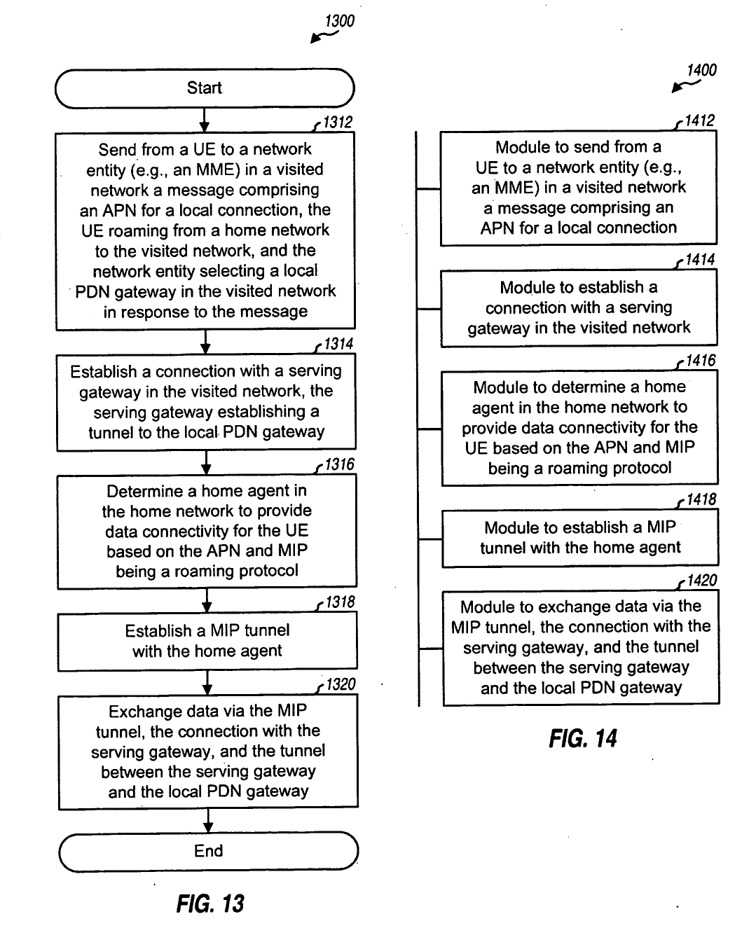

FIG. 13 shows a design of a process 1300 for obtaining data connectivity while roaming between wireless communication networks. Process 1300 may be performed by a UE or some other entity. A message comprising an APN for a local connection may be sent from the UE to a network entity in a visited network (block 1312). The UE may be roaming from a home network to the visited network. The network entity may be an MME and may select a local PDN gateway in the visited network in response to the message.

A connection may be established with a serving gateway in the visited network (block 1314). The serving gateway may be selected by the MME and may establish a tunnel to the local PDN gateway. A home agent in the home network to provide data connectivity for the UE may be determined based on the APN and MIP being a roaming protocol (block 1316). In one design of block 1316, a DNS query comprising the APN and an indication of MIP being the roaming protocol may be sent, and a DNS response comprising an address of the home agent may be received. A MIP tunnel may be established with the home agent (block 1318). Data may then be exchanged via the MIP tunnel, the connection with the serving gateway, and the tunnel between the serving gateway and the local PDN gateway (block 1320).

FIG. 14 shows a design of an apparatus 1400 for obtaining data connectivity while roaming between wireless communication networks. Apparatus 1400 includes a module 1412 to send a message comprising an APN for a local connection from a UE to a network entity in a visited network, with the UE roaming from a home network to the visited network, and the network entity selecting a local PDN gateway in the visited network in response to the message, a module 1414 to establish a connection with a serving gateway in the visited network, a module 1416 to determine a home agent in the home network to provide data connectivity for the UE based on the APN and MIP being a roaming protocol, a module 1418 to establish a MIP tunnel with the home agent, and a module 1420 to exchange data via the MIP tunnel, the connection with the serving gateway, and the tunnel between the serving gateway and the local PDN gateway.

The modules in FIGS. 6, 8, 10, 12 and 14 may comprise processors, electronics devices, hardware devices, electronics components, logical circuits, memories, etc., or any combination thereof.

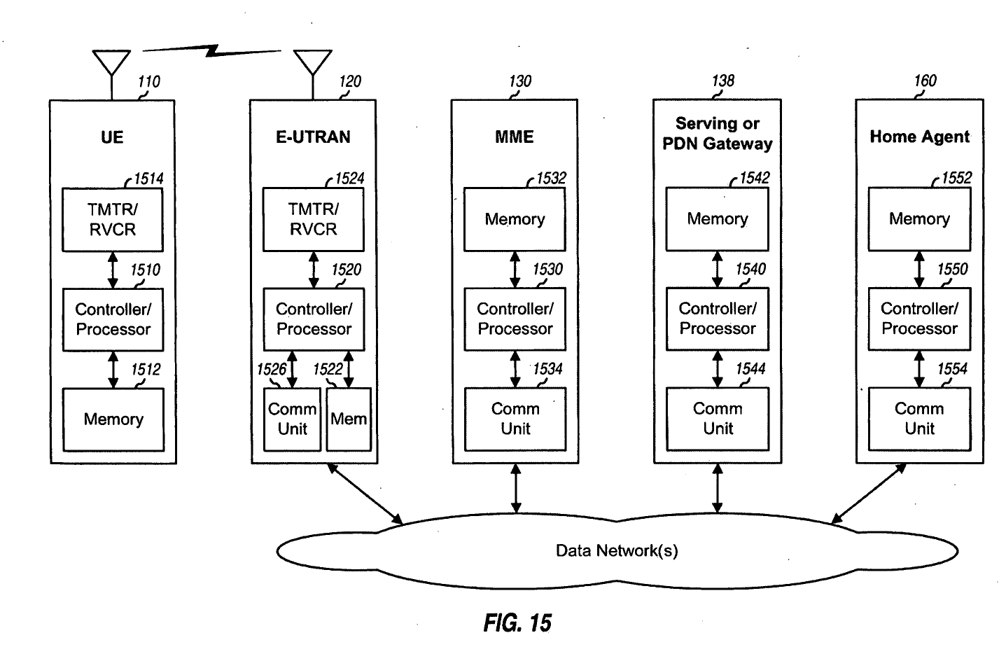

FIG. 15 shows a block diagram of a design of UE 110, E-UTRAN 120, MME 130, a serving or PDN gateway 138, and home agent 160. Gateway 138 may be serving gateway 140, PDN gateway 150, or PDN gateway 170 in FIGS. 1A and 1B. For simplicity, FIG. 15 shows (i) one controller/processor 1510, one memory 1512, and one transmitter/receiver (TMTR/RCVR) 1514 for UE 110, (ii) one controller/processor 1520, one memory (Mem) 1522, one transmitter/receiver 1524, and one communication (Comm) unit 1526 for E-UTRAN 120, (iii) one controller/processor 1530, one memory 1532, and one communication unit 1534 for MME 130, (iv) one controller/processor 1540, one memory 1542, and one communication unit 1544 for serving or PDN gateway 138, and (v) one controller/processor 1550, one memory 1552, and one communication unit 1554 for home agent 160. In general, each entity may include any number of controllers, processors, memories, transceivers, communication units, etc.

On the downlink, eNBs in E-UTRAN 120 may transmit data and messages to UEs within their coverage areas. The data and messages may be processed by processor 1520 and conditioned by transmitter 1524 to generate downlink signals, which may be transmitted to the UEs. At UE 110, the downlink signals from the eNBs may be received via an antenna, conditioned by receiver 1514, and processed by processor 1510 to obtain data and messages sent to UE 110. Memory 1512 may store program codes and data for UE 110. Processor 1510 may perform or direct process 500 in FIG. 5, process 1100 in FIG. 11, process 1300 in FIG. 13, and/or other processes for the techniques described herein. Processor 1510 may also perform the processing for UE 110 in message flows 200, 300 and 400 in FIGS. 2, 3 and 4, respectively.

On the uplink, UE 110 may transmit data and messages to eNBs in E-UTRAN 120. The data and messages may be processed by processor 1510 and conditioned by transmitter 1514 to generate an uplink signal, which may be transmitted to the eNBs. At E-UTRAN 120, the uplink signals from UE 110 and other UEs may be received and conditioned by receiver 1524 and further processed by processor 1520 to obtain data and messages sent by the UEs. Memory 1522 may store program codes and data for E-UTRAN 120, which may communicate with other network entities via communication unit 1526.

Within MME 130, processor 1530 may perform processing for the MME, memory 1532 may store program codes and data for the MME, and communication unit 1534 may allow the MME to communicate with other entities. Processor 1530 may perform or direct process 500 in FIG. 5, process 700 in FIG. 7, process 900 in FIG. 9, and/or other processes for the techniques described herein. Processor 1530 may also perform the processing for MME 130 in message flows 200, 300 and 400 in FIGS. 2, 3 and 4, respectively.

Within serving or PDN gateway 138, processor 1540 may perform processing for the gateway, memory 1542 may store program codes and data for the gateway, and communication unit 1544 map allow the gateway to communicate with other entities. Processor 1540 may perform or direct process 500 in FIG. 5, process 700 in FIG. 7, process 900 in FIG. 9, and/or other processes for the techniques described herein. Processor 1540 may also perform the processing for serving gateway 140, PDN gateway 150, or PDN gateway 170 in message flows 200, 300 and 400 in FIGS. 2, 3 and 4, respectively.

Within home agent 160, processor 1550 may perform processing for the home agent, memory 1552 may store program codes and data for the home agent, and communication unit 1554 may allow the home agent to communicate with other entities. Processor 1550 may perform the processing for home agent 160 in message flows 200, 300 and 400 in FIGS. 2, 3 and 4, respectively.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of supporting roaming in wireless communication networks, comprising:
obtaining an access point name (APN) and a preferred roaming protocol for a user equipment (UE) roaming from a home network to a visited network; and
determining a network entity to provide data connectivity for the UE based on the APN and the preferred roaming protocol.

2. The method of claim 1, wherein the obtaining the APN and the preferred roaming protocol comprises
receiving the APN from the UE or a home subscriber server (HSS) in the home network, and
receiving the preferred roaming protocol from the HSS.

3. The method of claim 1, further comprising:
selecting a packet data network (PDN) gateway in the visited network or the home network based on the preferred roaming protocol, wherein data connectivity for the UE is provided through the PDN gateway.

4. The method of claim 1, wherein the determining the network entity comprises
selecting a packet data network (PDN) gateway in the home network as the network entity if the preferred roaming protocol is GPRS Tunneling Protocol (GTP), and
selecting a home agent (HA) in the home network as the network entity if the preferred roaming protocol is Mobile Internet Protocol (MIP) or Proxy Mobile Internet Protocol (PMIP).

5. The method of claim 1, wherein the determining the network entity comprises
sending a domain name system (DNS) query comprising the APN and the preferred roaming protocol, and
receiving a DNS response comprising an address of the network entity.

6. The method of claim 5, wherein the DNS query comprises an SRV query and the preferred roaming protocol is explicitly provided in the SRV query.

7. The method of claim 5, wherein the DNS query comprises an A query or an AAAA query and the preferred roaming protocol is embedded in an APN name.

8. The method of claim 1, wherein the APN and the preferred roaming protocol are obtained by a mobility management entity (MME) in the visited network, and wherein the determining the network entity comprises discovering a packet data network (PDN) gateway in the home network as the network entity based on the APN and the preferred roaming protocol.

9. The method of claim 1, wherein the APN and the preferred roaming protocol are obtained by a packet data network (PDN) gateway or a serving gateway in the visited network, and wherein the determining the network entity comprises discovering a home agent (HA) in the home network as the network entity based on the APN and the preferred roaming protocol.

10. The method of claim 1, wherein the APN and the preferred roaming protocol are obtained by the UE, and wherein the determining the network entity comprises discovering a home agent (HA) in the home network as the network entity based on the APN and the preferred roaming protocol.

11. The method of claim 1, wherein the APN is associated with a data service requested by the UE.

12. The method of claim 1, wherein the preferred roaming protocol is GPRS Tunneling Protocol (GTP), Mobile Internet Protocol (MIP), or Proxy Mobile Internet Protocol (PMIP).

13. An apparatus for wireless communication, comprising:
at least one processor configured to obtain an access point name (APN) and a preferred roaming protocol for a user equipment (UE) roaming from a home network to a visited network, and to determine a network entity to provide data connectivity for the UE based on the APN and the preferred roaming protocol.

14. The apparatus of claim 13, wherein the at least one processor is configured to receive the APN from the UE or a home subscriber server (HSS) in the home network, and to receive the preferred roaming protocol from the HSS.

15. The apparatus of claim 13, wherein the at least one processor is configured to select a packet data network (PDN) gateway in the visited network or the home network based on the preferred roaming protocol, and wherein data connectivity for the UE is provided through the PDN gateway.

16. The apparatus of claim 13, wherein the at least one processor is configured to select a packet data network (PDN) gateway in the home network as the network entity if the preferred roaming protocol is GPRS Tunneling Protocol (GTP), and to select a home agent (HA) in the home network as the network entity if the preferred roaming protocol is Mobile Internet Protocol (MIP) or Proxy Mobile Internet Protocol (PMIP).

17. The apparatus of claim 13, wherein the at least one processor is configured to send a domain name system (DNS) query comprising the APN and the preferred roaming protocol, and to receive a DNS response comprising an address of the network entity.

18. An apparatus for wireless communication, comprising:
means for obtaining an access point name (APN) and a preferred roaming protocol for a user equipment (UE) roaming from a home network to a visited network; and
means for determining a network entity to provide data connectivity for the UE based on the APN and the preferred roaming protocol.

19. The apparatus of claim 18, wherein the means for obtaining the APN and the preferred roaming protocol comprises
means for receiving the APN from the UE or a home subscriber server (HSS) in the home network, and
means for receiving the preferred roaming protocol from the HSS.

20. The apparatus of claim 18, further comprising:
means for selecting a packet data network (PDN) gateway in the visited network or the home network based on the preferred roaming protocol, wherein data connectivity for the UE is provided through the PDN gateway.

21. The apparatus of claim 18, wherein the means for determining the network entity comprises
means for selecting a packet data network (PDN) gateway in the home network as the network entity if the preferred roaming protocol is GPRS Tunneling Protocol (GTP), and
means for selecting a home agent (HA) in the home network as the network entity if the preferred roaming protocol is Mobile Internet Protocol (MIP) or Proxy Mobile Internet Protocol (MIP).

22. The apparatus of claim 18, wherein the means for determining the network entity comprises
means for sending a domain name system (DNS) query comprising the APN and the preferred roaming protocol, and
means for receiving a DNS response comprising an address of the network entity.

23. A computer program product, comprising:
a computer-readable medium comprising:
code for causing at least one computer to obtain an access point name (APN) and a preferred roaming protocol for a user equipment (UE) roaming from a home network to a visited network, and
code for causing the at least one computer to determine a network entity to provide data connectivity for the UE based on the APN and the preferred roaming protocol.

24. The computer program product of claim 23, the computer-readable medium further comprising:
code for causing the at least one computer to select a packet data network (PDN) gateway in the home network as the network entity if the preferred roaming protocol is GPRS Tunneling Protocol (GTP), and
code for causing the at least one computer to select a home agent (HA) in the home network as the network entity if the preferred roaming protocol is Mobile Internet Protocol (MIP) or Proxy Mobile Internet Protocol (PMIP).

25. A method of supporting roaming in wireless communication networks, comprising:
obtaining an access point name (APN) and an indication of GPRS Tunneling Protocol (GTP) being a preferred roaming protocol for a user equipment (UE) roaming from a home network to a visited network; and
determining a packet data network (PDN) gateway in the home network to provide data connectivity for the UE based on the APN and the indication of GTP being the preferred roaming protocol.

26. The method of claim 25, wherein the obtaining the APN and the indication of GTP being the preferred roaming protocol comprises
receiving the APN from the UE or a home subscriber server (HSS) in the home network, and
receiving the indication of GTP being the preferred roaming protocol from the HSS.

27. The method of claim 25, wherein the determining the PDN gateway comprises
sending a domain name system (DNS) query comprising the APN and the indication of GTP being the preferred roaming protocol, and
receiving a DNS response comprising an address of the PDN gateway.

28. The method of claim 25, further comprising:
sending an address of the PDN gateway to a serving gateway in the visited network, wherein the serving gateway establishes a GTP tunnel with the PDN gateway for transporting data for the UE.

29. A method of supporting roaming in wireless communication networks, comprising:
obtaining an access point name (APN) and an indication of Proxy Mobile Internet Protocol (PMIP) being a preferred roaming protocol for a user equipment (UE) roaming from a home network to a visited network;
selecting a local packet data network (PDN) gateway in the visited network in response to the indication of PMIP being the preferred roaming protocol; and
sending the APN, the indication of PMIP being the preferred roaming protocol, and an address of the local PDN gateway to a serving gateway, wherein the local PDN gateway or the serving gateway determines a home agent (HA) in the home network to provide data connectivity for the UE based on the APN and the indication of PMIP being the preferred roaming protocol.

30. The method of claim 29, wherein the obtaining the APN and the indication of PMIP being the preferred roaming protocol comprises
receiving the APN from the UE or a home subscriber server (HSS) in the home network, and
receiving the indication of PMIP being the preferred roaming protocol from the HSS.

31. A method of obtaining data connectivity while roaming between wireless communication networks, comprising:
sending a message comprising an access point name (APN) from a user equipment (UE) to a first network entity in a visited network, wherein the UE is roaming from a home network to the visited network; and
exchanging data via a second network entity in the home network, wherein the second network entity is determined based on the APN and a preferred roaming protocol for the UE.

32. The method of claim 31, wherein the second network entity is a packet data network (PDN) gateway determined based on the APN and GPRS Tunneling Protocol (GTP) being the preferred roaming protocol.

33. The method of claim 31, wherein the second network entity is a home agent (HA) determined based on the APN and Proxy Mobile Internet Protocol (PMIP) being the preferred roaming protocol.

34. An apparatus for wireless communication, comprising:
at least one processor configured to send a message comprising an access point name (APN) from a user equipment (UE) to a first network entity in a visited network, and to exchange data via a second network entity in the home network, wherein the UE is roaming from a home network to the visited network, and wherein the second network entity is determined based on the APN and a preferred roaming protocol for the UE.

35. The apparatus of claim 34, wherein the second network entity is a packet data network (PDN) gateway determined based on the APN and GPRS Tunneling Protocol (GTP) being the preferred roaming protocol.

36. The apparatus of claim 34, wherein the second network entity is a home agent (HA) determined based on the APN and Proxy Mobile Internet Protocol (PMIP) being the preferred roaming protocol.

37. A method of obtaining data connectivity while roaming between wireless communication networks, comprising:
sending from a user equipment (UE) to a network entity in a visited network a message comprising an access point name (APN) for a local connection, wherein the UE is roaming from a home network to the visited network, and wherein the network entity selects a local packet data network (PDN) gateway in the visited network in response to the message;
establishing a connection with a serving gateway in the visited network, wherein the serving gateway establishes a tunnel to the local PDN gateway; and
determining a home agent (HA) in the home network to provide data connectivity for the UE based on the APN and Mobile Internet Protocol (MIP) being a roaming protocol.

38. The method of claim 37, further comprising:
establishing a MIP tunnel with the home agent; and
exchanging data via the MIP tunnel, the connection with the serving gateway, and the tunnel between the serving gateway and the local PDN gateway.

39. The method of claim 37, wherein the determining the home agent comprises
sending a domain name system (DNS) query comprising the APN and an indication of MIP being the roaming protocol, and
receiving a DNS response comprising an address of the home agent.

40. An apparatus for wireless communication, comprising:
at least one processor configured to send from a user equipment (UE) to a network entity in a visited network a message comprising an access point name (APN) for a local connection, wherein the UE is roaming from a home network to the visited network, and wherein the network entity selects a local packet data network (PDN) gateway in the visited network in response to the message, to establish a connection with a serving gateway in the visited network, wherein the serving gateway establishes a tunnel to the local PDN gateway, and to determine a home agent (HA) in the home network to provide data connectivity for the UE based on the APN and Mobile Internet Protocol (MIP) being a roaming protocol.

41. The apparatus of claim 40, wherein the at least one processor is configured to establish a MIP tunnel with the home agent, and to exchange data via the MIP tunnel, the connection with the serving gateway, and the tunnel between the serving gateway and the local PDN gateway.

42. The apparatus of claim 40, wherein the at least one processor is configured to send a domain name system (DNS) query comprising the APN and an indication of MIP being the roaming protocol, and to receive a DNS response comprising an address of the home agent.
